(19) United States
(12) Patent Application Publication
(10) Pub. No.: US 2017/0006358 A1
(43) Pub. Date: Jan. 5, 2017

(54) SENSOR INFORMATION MANAGEMENT DEVICE, SENSOR INFORMATION MANAGEMENT METHOD, AND SENSOR INFORMATION MANAGEMENT PROGRAM

(71) Applicant: SUMITOMO ELECTRIC INDUSTRIES, LTD., Osaka-shi (JP)

(72) Inventor: Hiromitsu KURIYAMA, Osaka-shi (JP)

(73) Assignee: Sumitomo Electric Industries, Ltd., Osaka (JP)

(21) Appl. No.: 15/115,294

(22) PCT Filed: May 20, 2015
(86) PCT No.: PCT/JP2015/064440

§ 371 Date: Jul. 29, 2016

(30) Foreign Application Priority Data
Jun. 2, 2014 (JP) 2014-113992

(51) Int. Cl. H04Q 9/00

(52) U.S. Cl. CPC H04Q 9/00

(57) ABSTRACT

In a configuration in which a measurement result obtained by a sensor is collected and provision information based on the collected measurement results and the like is provided, a sensor information management device and the like that can provide appropriate provision information are provided. The sensor information management device includes: a sensor information obtaining unit configured to obtain sensor information, from a storage unit configured to store the sensor information indicating at least either one of a measurement result obtained by a sensor and a communication quality of the sensor; and an information providing unit configured to provide provision information based on a content of the sensor information obtained by the sensor information obtaining unit, wherein the information providing unit changes a content of the provision information in accordance with what a provision destination of the provision information is.

### TECHNICAL FIELD

The present invention relates to a sensor information management device, a sensor information management method, and a sensor information management program, and in particular, relates to a sensor information management device, a sensor information management method, and a sensor information management program which manage sensor information indicating a measurement result and the like obtained by a sensor.

### BACKGROUND ART

Communication services have been provided that use wireless base station devices each forming a cell which is an area where wireless terminal devices are allowed to perform communication. As a system utilizing such a communication service and the like, an M2M (machine to machine) system is known. In the M2M system, for example, apparatuses each having a wireless device installed therein transmit/receive information to/from each other not via manual operation, whereby the apparatuses are automatically controlled.

As one example of the M2M system, for example, PATENT LITERATURE 1 (Japanese Patent No. 4237134) discloses the following technology. That is, disclosed is a network system in which a mobile communication network which includes: a wireless terminal; gateway nodes which are wirelessly communicable with the wireless terminal; and a positional information storage device which retains positional information of the wireless terminal is connected via a gateway to another network to which a terminal being a destination to which a message is transmitted from the wireless terminal is connected. The network system has terminal address retaining means which retains the address of the terminal being the transmission destination which has been determined in advance for each wireless terminal. In a case where a message is to be transmitted from a wireless terminal to the aforementioned terminal, if a gateway node receives a wireless frame from the wireless terminal, the gateway node accesses the terminal address retaining means, identifies the terminal address of the message transmission destination for the wireless terminal, and transmits the message via the gateway to the terminal of the identified transmission destination. In a case where a message is to be transmitted from the aforementioned terminal to the wireless terminal, the gateway accesses the positional information storage device, obtains positional information from the ID of the wireless terminal, and transfers the message to the corresponding gateway node on the basis of the obtained positional information. The gateway node transfers the message to the wireless terminal.

### CITATION LIST

### Patent Literature

PATENT LITERATURE 1: Japanese Patent No. 4237134

### SUMMARY OF INVENTION

### Technical Problem

As one mode utilizing such an M2M system, it is conceivable to: set one or a plurality of wireless terminal devices that can each wirelessly transmit a measurement result obtained by a sensor; collect measurement results from the wireless terminal devices; and provide information based on the collected measurement results and the like. In such a utilization mode, there is a demand for a technology that can provide appropriate information.

The present invention has been made in order to solve the above problem. An object of the present invention is to provide a sensor information management device, a sensor information management method, and a sensor information management program which are capable of providing appropriate provision information, in a configuration in which measurement results obtained by a sensor are collected and provision information based on the collected measurement results and the like is provided.

### Solution to Problem

(1) In order to solve the above problem, a sensor information management device according to an aspect of the present invention includes: a sensor information obtaining unit configured to obtain sensor information, from a storage unit configured to store the sensor information indicating at least either one of a measurement result obtained by a sensor and a communication quality of the sensor; and an information providing unit configured to provide provision information based on a content of the sensor information obtained by the sensor information obtaining unit, wherein the information providing unit changes a content of the provision information in accordance with what a provision destination of the provision information is.

(4) In order to solve the above problem, a sensor information management method according to an aspect of the present invention is a sensor information management method to be performed in a sensor information management device, the method including the steps of: obtaining sensor information from a storage unit configured to store the sensor information indicating at least either one of a measurement result obtained by a sensor and a communication quality of the sensor; and providing provision information based on a content of the obtained sensor information, wherein in the step of providing the provision information, a content of the provision information is changed in accordance with what a provision destination of the provision information is.

(5) In order to solve the above problem, a sensor information management program according to an aspect of the present invention is a sensor information management program to be used in a sensor information management device, the program causing a computer to execute the steps of: obtaining sensor information from a storage unit configured to store the sensor information indicating at least either one of a measurement result obtained by a sensor and a communication quality of the sensor; and providing provision information based on a content of the obtained sensor information, wherein in the step of providing the provision information, a content of the provision information is changed in accordance with what a provision destination of the provision information is.

The present invention can not only be realized as a sensor information management device provided with such a characteristic processing unit, but can also be realized as a semiconductor integrated circuit which realizes a part or the entirety of the sensor information management device, or as a system provided with the sensor information management device.

### Advantageous Effects of Invention

According to the present invention, in a configuration in which measurement results obtained by a sensor are collected and provision information based on the collected measurement results and the like is provided, it is possible to provide appropriate provision information.

### BRIEF DESCRIPTION OF DRAWINGS

FIG. 1 shows a configuration of a sensor information collection system according to an embodiment of the present invention.

FIG. 2 shows a configuration of a sensor in a management system according to the embodiment of the present invention.

FIG. 3 shows one example of a csv file stored in an accumulation device in the management system according to the embodiment of the present invention.

FIG. 4 shows a configuration of a sensor information management system according to the embodiment of the present invention.

FIG. 5 shows a configuration of a sensor information management device in the sensor information management system according to the embodiment of the present invention.

FIG. 6 shows one example of an access permission table retained by a list retaining unit in the sensor information management device according to the embodiment of the present invention.

FIG. 7 shows one example of a notification permission table retained by the list retaining unit in the sensor information management device according to the embodiment of the present invention.

FIG. 8 is a flow chart specifying the procedure of operations performed when the sensor information management device according to the embodiment of the present invention provides provision information based on the content of sensor information.

FIG. 9 is a flow chart specifying the procedure of operations performed when the sensor information management device according to the embodiment of the present invention has received an access request from a terminal computer.

FIG. 10 is a flow chart specifying the procedure of operations performed when the sensor information management device according to the embodiment of the present invention notifies a terminal computer of sensor information.

FIG. 11 is a flow chart specifying the procedure of operations performed when the sensor information management device according to the embodiment of the present invention notifies a terminal computer of alarm information.

### DESCRIPTION OF EMBODIMENTS

First, the contents of the embodiment of the present invention will be listed and described.

(1) A sensor information management device according to an embodiment of the present invention includes: a sensor information obtaining unit configured to obtain sensor information, from a storage unit configured to store the sensor information indicating at least either one of a measurement result obtained by a sensor and a communication quality of the sensor; and an information providing unit configured to provide provision information based on a content of the sensor information obtained by the sensor information obtaining unit, wherein the information providing unit changes a content of the provision information in accordance with what a provision destination of the provision information is.

The “sensor information” above includes the measurement value of at least any one of LQI, battery voltage, temperature, humidity, illuminance, acceleration, and electric current, for example. The “provision information based on a content of the sensor information” above includes at least either one of alarm information and a part or an entirety of the sensor information, for example.

With this configuration, in accordance with what the provision destination of the provision information is, the content of the provision information can be restricted, or provision of the provision information can be avoided, for example. Accordingly, confidentiality can be maintained, and the transmission efficiency of the provision information can be improved.

Therefore, with respect to the sensor information management device according to the embodiment of the present invention, in a configuration in which measurement results obtained by the sensor are collected and provision information based on the collected measurement results and the like is provided, it is possible to provide appropriate provision information.

(2) Preferably, the information providing unit provides, as the provision information, one or a plurality of kinds of the sensor information in accordance with what the provision destination is, among a plurality of kinds of the sensor information stored in the storage unit.

With this configuration, even in a case where the kind of sensor information that should be kept confidential differs depending on what the provision destination is, it is possible to provide appropriate sensor information.

(3) Preferably, the information providing unit is capable of performing a first operation that provides the provision destination with the provision information in response to a request from the provision destination, and a second operation that provides the provision destination with the provision information irrespective of the request, and the information providing unit is capable of providing the provision destination with the provision information having a content that is different between the first operation and the second operation.

Thus, for example, it is possible to avoid a state where provision information that is unnecessary in a normal state is periodically transmitted due to a configuration in which: provision information that is necessary in a normal state is provided through an “operation that provides the provision destination with the provision information irrespective of the request”; and provision information that is necessary in an abnormal situation is not provided through such operation but is provided through the “operation that provides the provision destination with the provision information in response to a request from the provision destination”. It is also possible to quickly provide provision information that is necessary in an abnormal state. Therefore, convenience for the provision destination can be improved, and the transmission efficiency of information can be further improved.

(4) A sensor information management method according to an embodiment of the present invention is a sensor information management method to be performed in a sensor information management device, the method including the steps of: obtaining sensor information from a storage unit configured to store the sensor information indicating at least either one of a measurement result obtained by a sensor and a communication quality of the sensor; and providing provision information based on a content of the obtained sensor information, wherein in the step of providing the provision information, a content of the provision information is changed in accordance with what a provision destination of the provision information is.

With this configuration, in accordance with what the provision destination of the provision information is, the content of the provision information can be restricted, or provision of the provision information can be avoided, for example. Accordingly, confidentiality can be maintained, and the transmission efficiency of the provision information can be improved.

Therefore, with respect to the sensor information management device according to the embodiment of the present invention, in a configuration in which measurement results obtained by the sensor are collected and provision information based on the collected measurement results and the like is provided, it is possible to provide appropriate provision information.

(5) A sensor information management program according to an embodiment of the present invention is a sensor information management program to be used in a sensor information management device, the program causing a computer to execute the steps of: obtaining sensor information from a storage unit configured to store the sensor information indicating at least either one of a measurement result obtained by a sensor and a communication quality of the sensor; and providing provision information based on a content of the obtained sensor information, wherein in the step of providing the provision information, a content of the provision information is changed in accordance with what a provision destination of the provision information is.

With this configuration, in accordance with what the provision destination of the provision information is, the content of the provision information can be restricted, or provision of the provision information can be avoided, for example. Accordingly, confidentiality can be maintained, and the transmission efficiency of the provision information can be improved.

Therefore, with respect to the sensor information management device according to the embodiment of the present invention, in a configuration in which measurement results obtained by the sensor are collected and provision information based on the collected measurement results and the like is provided, it is possible to provide appropriate provision information.

Hereinafter, an embodiment of the present invention will be described with reference to the drawings. In the drawings, the same or corresponding parts are denoted by the same reference signs, and description thereof is not repeated. At least some parts of the embodiment described below can be combined together as desired.

[Sensor Information Collection System]

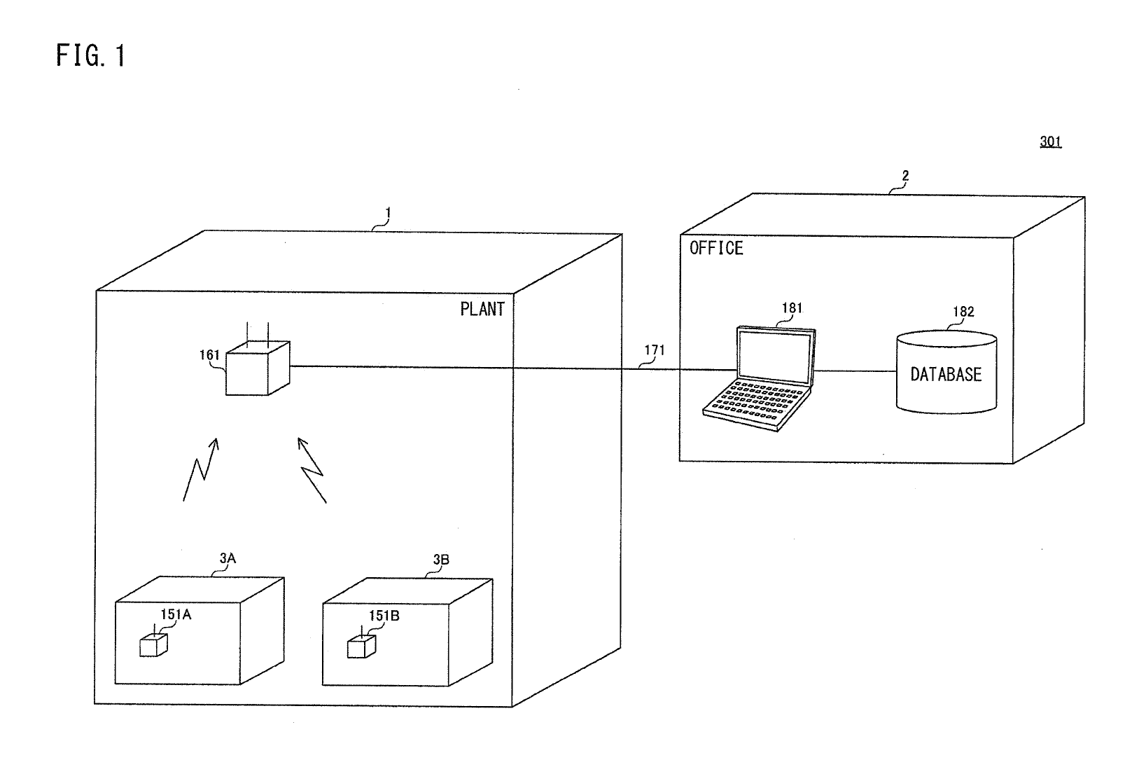

FIG. 1 shows a configuration of a sensor information collection system according to an embodiment of the present invention.

With reference to FIG. 1, a sensor information collection system 301 includes: sensors 151A and 151B; an access point 161; a collection device 181; and an accumulation device (storage unit) 182. Hereinafter, each of the sensors 151A and 151B will also be referred to as a sensor 151.

It should be noted that the sensor information collection system 301 may be configured to include one sensor 151, or may be configured to include three or more sensors 151.

The sensor information collection system 301 is installed in, for example, a plant 1 and an office 2 of a business entity. For example, in the sensor information collection system 301, information regarding facilities 3A and 3B in the plant 1 and information regarding communication and operation of each sensor 151 are collected. In this example, the access point 161 and the sensor 151 are provided in the plant 1, and the accumulation device 182 and the collection device 181 are provided in the office 2. Hereinafter, each of the facilities 3A and 3B will also be referred to as a facility 3.

The sensor 151 performs measurement regarding a measurement target, specifically, regarding the state and environment of the facility 3 installed in the plant 1 and the operation state of the sensor 151 itself, and transmits a wireless signal that contains sensor measurement information indicating the measurement result, to the access point 161. More specifically, the sensor 151 is provided in the facility 3 in the plant 1.

FIG. 1 shows a case as one example in which: a plurality of the facilities 3 are provided in the plant 1; and a plurality of the sensors 151 provided so as to correspond to the facilities 3 are provided in their corresponding facilities 3. A configuration may be adopted in which: some or all of the sensors 151 transmit sensor measurement information to the access point 161 through wired communication.

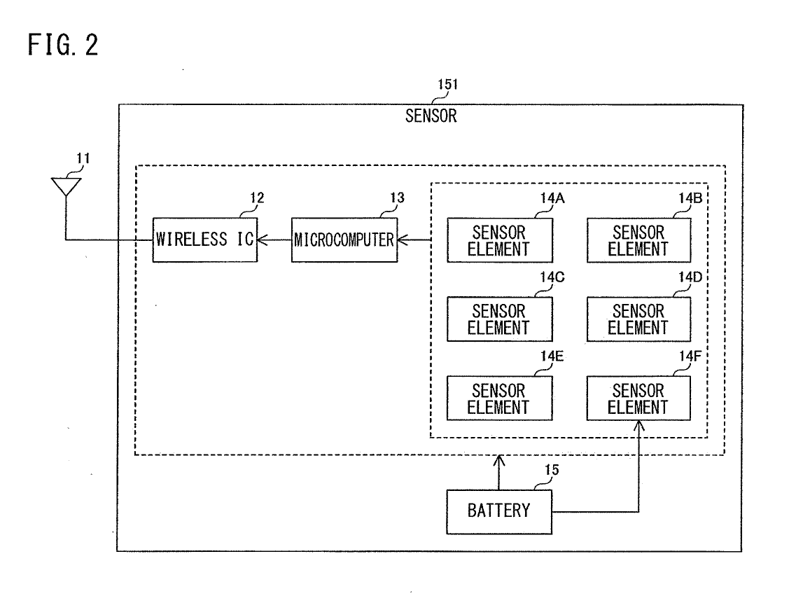

FIG. 2 shows a configuration of a sensor in a management system according to the embodiment of the present invention.

With reference to FIG. 2, the sensor 151 includes an antenna 11, a wireless IC (integrated circuit) 12, a microcomputer 13, sensor elements 14A to 14F, and a battery 15. The microcomputer 13 is realized by, for example, a CPU (central processing unit). A configuration may be adopted in which, for example, the wireless IC 12 and the microcomputer 13 are included in one semiconductor integrated circuit.

Hereinafter, each of the sensor elements 14A to 14F will also be referred to as a sensor element 14. The sensor 151 may be configured to include five or less sensor elements 14, or may be configured to include seven or more sensor elements 14.

The wireless IC 12, the microcomputer 13, and each sensor element 14 in the sensor 151 operate by using electric power received from the battery 15, for example.

Specifically, for example, the sensor elements 14A, 14B, and 14C are respectively a temperature sensor element, a humidity sensor element, and an illuminance sensor element; respectively measure the temperature, the humidity, and the illuminance around themselves as the environment of the facility 3 being the measurement target; and respectively output facility environment information indicating the temperature, the humidity, and the illuminance that have been measured, to the microcomputer 13 via an I2C bus (registered trade mark), for example.

For example, the sensor elements 14D and 14E are respectively an acceleration sensor element and an electric current sensor element; respectively measure the acceleration and the electric current consumption of a production device in the facility 3, for example, as a state of the facility 3 being the measurement target; and respectively output facility state information indicating the acceleration and the electric current that have been measured, to the microcomputer 13 via the I2C bus, for example.

For example, the sensor element 14F is a voltage sensor element, measures the voltage of the battery 15 as an operation state of the sensor 151 in which the sensor element 14F is included, and outputs sensor operation state information including a voltage value of the battery 15 being the measurement result, to the microcomputer 13 via the I2C bus, for example.

It should be noted that the sensor 151 may be configured to include, in addition to or instead of the sensor elements 14 as described above, a sensor that performs another measurement of such as, for example, atmospheric pressure, angle, angular velocity, magnetic force, carbon dioxide concentration, or carbon monoxide gas concentration.

The microcomputer 13 causes the facility environment information, the facility state information, and the sensor operation state information that have been received from the sensor elements 14, to be included, as sensor measurement information, in a packet of a frame format in accordance with the IEEE802.15.4 standard, for example, and outputs the packet to the wireless IC 12. Thus, the sensor measurement information indicates the measurement result obtained by the sensor 151. Moreover, the microcomputer 13 causes the packet to include the ID and the like of the sensor 151 in which the microcomputer 13 is included, and outputs the packet to the wireless IC 12.

The wireless IC 12 converts the packet received from the microcomputer 13 into a wireless signal in accordance with the IEEE802.15.4 standard, for example, and transmits the resultant wireless signal from the antenna 11.

With reference to FIG. 1 again, the access point 161 receives the wireless signal from each sensor 151, and transmits the sensor measurement information contained in the received wireless signal to the collection device 181 via a network 171 such as Ethernet (registered trade mark) or a wireless LAN (local area network). For example, the access point 161 adds time information such as a time stamp, and communication quality information indicating the communication quality of the sensor 151, specifically, link quality indication (LQI) for wireless communication, etc., to the sensor measurement information, and transmits the resultant sensor measurement information to the collection device 181. Thus, the communication quality information indicates the communication quality of the sensor 151. Here, a greater value of the LQI indicates a better link quality, for example.

[csv File]

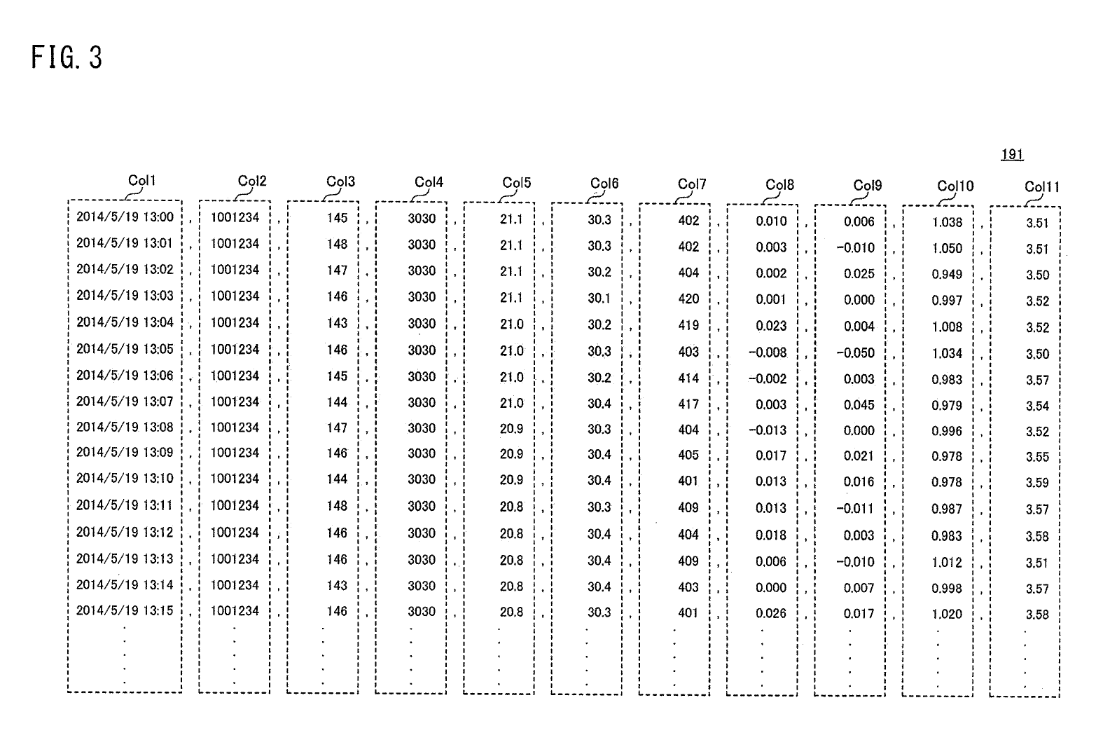

FIG. 3 shows one example of a csv file stored in an accumulation device in the management system according to the embodiment of the present invention.

With reference to FIG. 3, the accumulation device 182 stores sensor information converted into a form of a database, specifically, a csv (comma-separated values) file 191. Here, in the csv file 191, different kinds of information in the respective columns separated by commas are stored in the time series order.

Specifically, in columns Col1 and Col2 of the csv file 191, a time stamp value indicating the sampling timing and an ID value of the sensor 151 are stored, respectively. In a column Col3, a value of LQI is stored.

In a column Col4, a voltage value of the battery 15 is stored in the unit of millivolt. In columns Col5, Col6, and Col7, measurement values of the temperature, the humidity, and the illuminance are stored in the units of Celsius degree, %, and lux, respectively. In columns Col8, Col9, and Col10, measurement values of the acceleration in the x-axis direction, the y-axis direction, and the z-axis direction are stored in the gravitational acceleration unit G, respectively. In a Col11, a measurement value of the electric current consumption of the production device is stored in the unit of ampere.

That is, in the column Col3 and the columns Col4 to Col11 of the csv file 191, the communication quality information and the sensor measurement information are respectively stored as the sensor information.

With reference to FIG. 1 again, the collection device 181 is a computer, for example. Upon receiving sensor information from the access point 161, the collection device 181 stores the received sensor information in the accumulation device 182, specifically, adds the sensor information to the csv file 191 stored in the accumulation device 182.

[Problem]

For example, a production management department, which manages the production device provided in the facility 3, manages the production condition on the basis of important process information, i.e., sensor information that is important for the manufacturing process in the facility 3, such as temperature, humidity, illuminance, acceleration, and electric current. Meanwhile, the wireless sensor manufacturer, which provides maintenance of the wireless communication between the sensor 151 and the access point 161, monitors the communication state between the sensor 151 and the access point 161 on the basis of, for example, the LQI and the voltage value of the battery 15 in the sensor information.

In this manner, there are cases where the kinds of sensor information targeted by requests from a business entity, a department, and the like differ depending on what the business entity, the department, and the like are.

For example, as shown in FIG. 3, in a case where all the sensor information is stored in one csv file 191, if the wireless sensor manufacturer which is to obtain the LQI and the voltage value of the battery 15 can access the csv file 191, the wireless sensor manufacturer can obtain the LQI and the voltage value of the battery 15, and also can obtain the important process information.

Therefore, in a case where the important process information is confidential within the entity, if the state is left as it is where the wireless sensor manufacturer being an outside manufacturer is allowed to access the important process information, the important process information could be leaked to the outside, which is not preferable.

Therefore, a sensor information management system according to the embodiment of the present invention solves such a problem by the following configuration and operations.

[Sensor Information Management System]

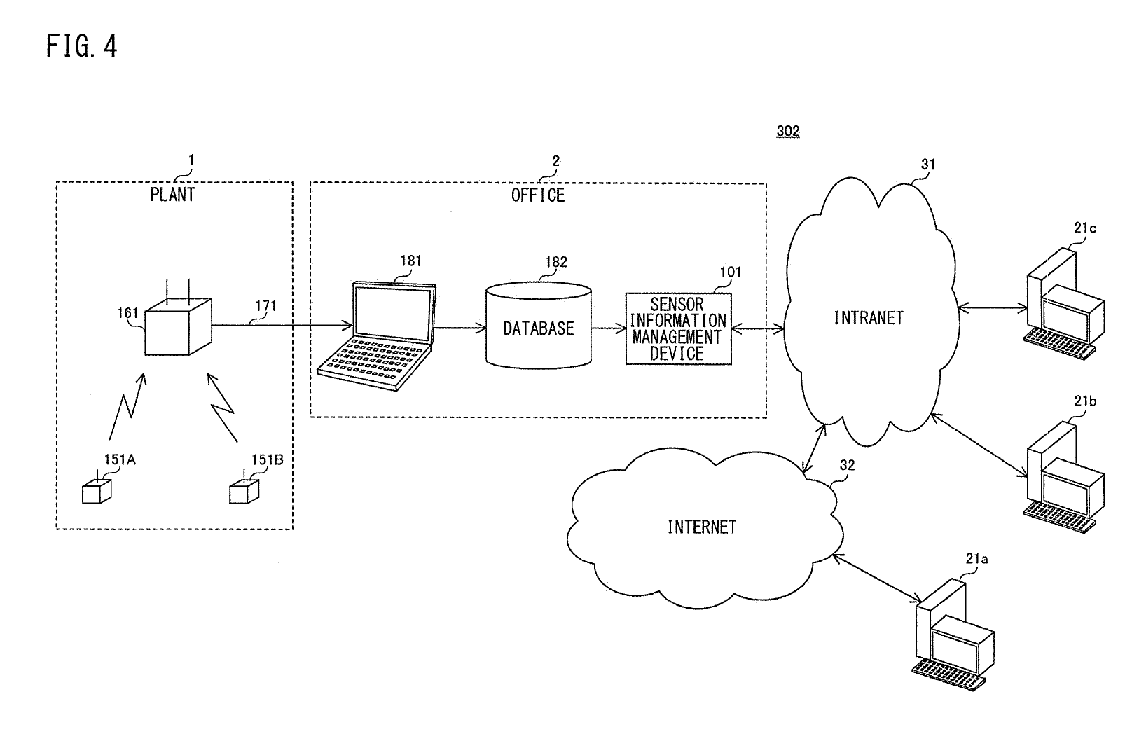

FIG. 4 shows a configuration of a sensor information management system according to the embodiment of the present invention.

With reference to FIG. 4, a sensor information management system 302 includes the sensors 151A and 151B, the access point 161, the collection device 181, the accumulation device (storage unit) 182, a sensor information management device 101, and terminal computers 21a, 21b, and 21c. Hereinafter, each of the terminal computers 21a, 21b, and 21c will also be referred to as a terminal computer 21. The sensor information management system 302 may be configured to include two terminal computers 21 or may be configured to include four or more terminal computers 21.

The operations of the sensors 151A and 151B, the access point 161, the collection device 181, and the accumulation device 182 are respectively the same as the operations of the sensors 151A and 151B, the access point 161, the collection device 181, and the accumulation device 182 in the sensor information collection system 301 shown in FIG. 1.

The sensor information management device 101 is communicably connected to the terminal computer 21a via an intranet 31 and the Internet 32, for example. The sensor information management device 101 is communicably connected to the terminal computers 21b and 21c via the intranet 31, for example.

The terminal computer 21a is a computer used in the wireless sensor manufacturer, for example. The terminal computer 21b is a computer used in an air conditioning management department, for example. The terminal computer 21c is a computer used in the production management department, for example.

Hereinafter, the terminal computers 21a, 21b, and 21c will also be referred to as a wireless manufacturer TC 21a, an air conditioning management TC 21b, and a production management TC 21c, respectively.

[Sensor Information Management Device]

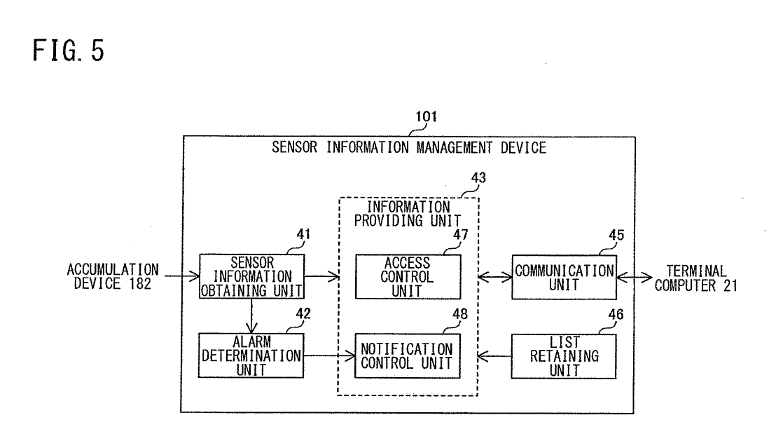

FIG. 5 shows a configuration of a sensor information management device in the sensor information management system according to the embodiment of the present invention.

With reference to FIG. 5, the sensor information management device 101 includes a sensor information obtaining unit 41, an alarm determination unit 42, an information providing unit 43, a communication unit 45, and a list retaining unit 46. The information providing unit 43 includes an access control unit 47 and a notification control unit 48.

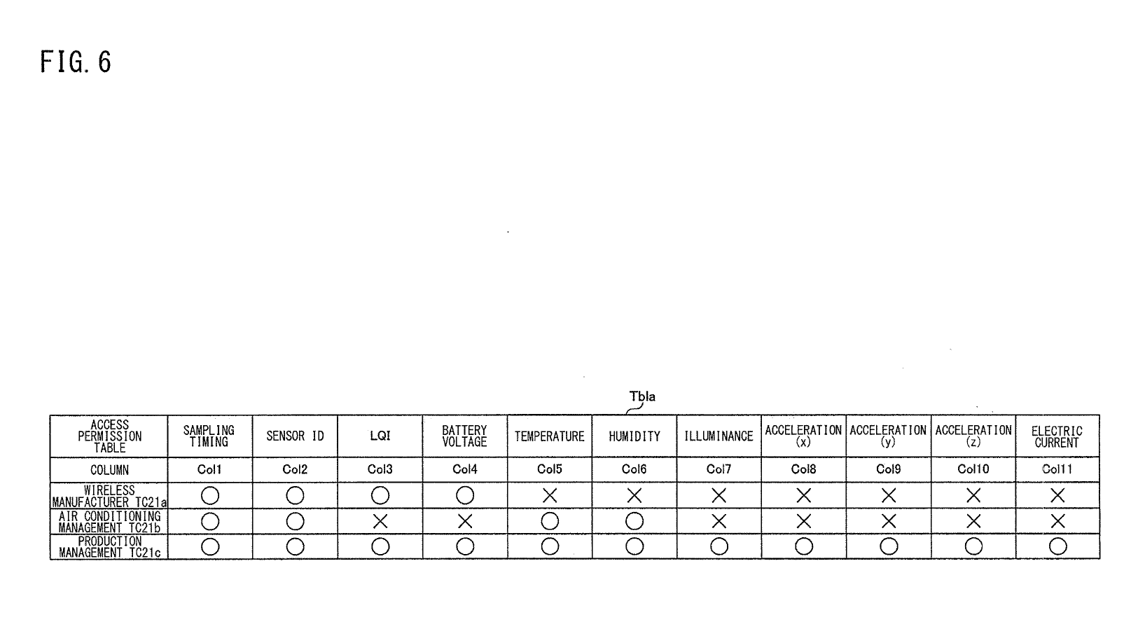

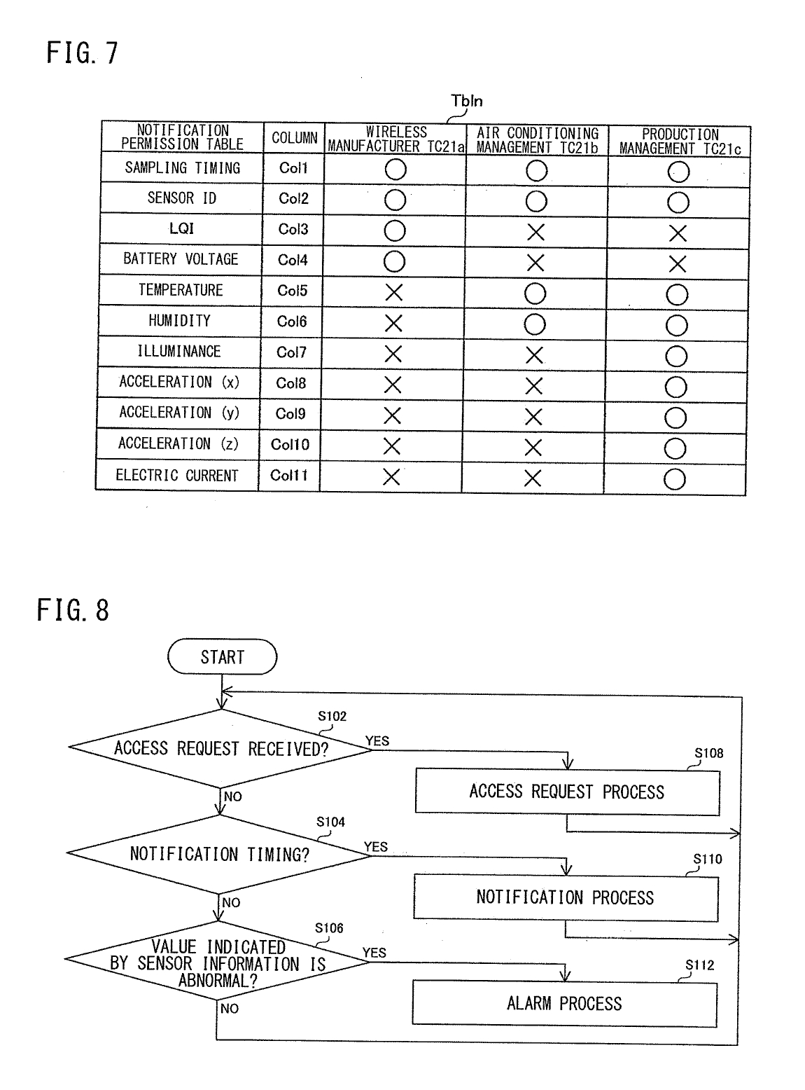

FIG. 6 shows one example of an access permission table retained by a list retaining unit in the sensor information management device according to the embodiment of the present invention. FIG. 7 shows one example of a notification permission table retained by the list retaining unit in the sensor information management device according to the embodiment of the present invention.

With reference to FIG. 5 to FIG. 7, the communication unit 45 in the sensor information management device 101 transmits/receives information to/from the wireless manufacturer TC 21a shown in FIG. 4 via the intranet 31 and the Internet 32, for example. In addition, the communication unit 45 transmits/receives information to/from the air conditioning management TC 21b and the production management TC 21c shown in FIG. 4 via the intranet 31, for example.

The list retaining unit 46 retains an access permission table Tbla and a notification permission table Tbln, for example.

The sensor information obtaining unit 41 obtains one or a plurality of kinds of sensor information from the accumulation device 182 which stores sensor information indicating measurement results obtained by each sensor 151 and the communication quality of the sensor 151.

The information providing unit 43 provides provision information based on the content of the sensor information obtained by the sensor information obtaining unit 41. In addition, the information providing unit 43 changes the content of the provision information in accordance with what the provision destination of the provision information is.

[Access Control]

For example, in a case where the terminal computer 21 shown in FIG. 4 is to obtain a specific kind of sensor information in the sensor information stored in the accumulation device 182, the terminal computer 21 transmits an access request for accessing the specific kind of sensor information, to the sensor information management device 101. At this time, for example, the terminal computer 21 causes the access request to include its own identifier as information of the transmission source, and transmits the resultant access request to the sensor information management device 101.

Specifically, for example, the wireless manufacturer TC 21a transmits, to the sensor information management device 101, an access request including the identifier of the wireless manufacturer TC 21a and a request for accessing the LQI in the column Col3 and the voltage value of the battery 15 in the column Col4 in the csv file 191 shown in FIG. 3 stored in the accumulation device 182.

The access control unit 47 in the information providing unit 43 can perform, in response to a request from a provision destination, an access permission operation that provides the provision information to the provision destination, for example. Specifically, for example, upon receiving an access request from the terminal computer 21, the access control unit 47 can perform an access permission operation that permits the terminal computer 21 to access sensor information that is based on the received access request.

Further, the access control unit 47 provides, as the provision information, one or a plurality of kinds of sensor information in accordance with what the provision destination is, among a plurality of kinds of sensor information stored in the accumulation device 182, for example.

More specifically, for example, upon receiving an access request from the wireless manufacturer TC 21a via the communication unit 45, the access control unit 47 refers to the access permission table Tbla shown in FIG. 6 retained in the list retaining unit 46, and performs the following process as the access permission operation.

That is, for example, on the basis of the content of the access request, the access control unit 47 recognizes that “o” is at the intersection of “wireless manufacturer TC 21a” and “Col3” and at the intersection of “wireless manufacturer TC 21a” and “Col4” in the access permission table Tbla, and determines that an access permission should be given to the wireless manufacturer TC 21a.

Then, for example, the access control unit 47 performs an access permission operation that permits the wireless manufacturer TC 21a to access the columns Col3 and Col4 in the csv file 191, and provides the wireless manufacturer TC 21a with the LQI value and the voltage value of the battery 15 as the provision information.

Meanwhile, for example, the air conditioning management TC 21b transmits, to the sensor information management device 101, an access request including the identifier of the air conditioning management TC 21b and a request for accessing the LQI in the column Col3 and the voltage value of the battery 15 in the column Col4 in the csv file 191.

Upon receiving an access request from the air conditioning management TC 21b via the communication unit 45, for example, the access control unit 47 refers to the access permission table Tbla. Then, for example, on the basis of the content of the access request, the access control unit 47 recognizes that “x” is at the intersection of “air conditioning management TC 21b” and “Col3” and at the intersection of “air conditioning management TC 21b” and “Col4” in the access permission table Tbla, and determines that an access permission should not be given to the air conditioning management TC 21b.

Then, the access control unit 47 performs an access blocking operation that prohibits the air conditioning management TC 21b from accessing the columns Col3 and Col4 in the csv file 191, for example. As described above, the access control unit 47 changes the content of the provision information in accordance with what the provision destination of the provision information is.

It should be noted that in a case where the access control unit 47 has received from the air conditioning management TC 21b an access request for accessing the LQI in the column Col3 and the temperature in the column Col5, for example, the access control unit 47 may perform the following process after recognition of “x” and “o” being respectively at the intersection of “air conditioning management TC 21b” and “Col3” and at the intersection of “air conditioning management TC 21b” and “Col5” in the access permission table Tbla. That is, the access control unit 47 may determine that an access permission limited to the column Col5 in the csv file 191 that corresponds to “o” should be given to the air conditioning management TC 21b, for example. Alternatively, the access control unit 47 may determine that an access permission should not be given to the air conditioning management TC 21b because “x” is at the intersection of “air conditioning management TC 21b” and “Col3” in the access permission table Tbla.

[Notification of Sensor Information]

A state is assumed where, in the sensor information management system 302, a schedule is set in which notification of each of various kinds of sensor information is made at a predetermined time to once a day, for example.

For example, the notification control unit 48 in the information providing unit 43 can perform a notification operation that provides, irrespective of a request from a provision destination, provision information to the provision destination. Specifically, for example, in accordance with the schedule, the notification control unit 48 can perform the notification operation that transmits sensor information as the provision information to a provision destination, i.e., the transmission destination based on the notification permission table Tbln shown in FIG. 7.

In addition, for example, the notification control unit 48 provides one or a plurality of kinds of sensor information in accordance with what the provision destination is, among a plurality of kinds of sensor information stored in the accumulation device 182.

More specifically, when the predetermined time to has come at which to make notification of the sensor information, the notification control unit 48 refers to the notification permission table Tbln retained in the list retaining unit 46, and performs the following process as the notification operation on the basis of the content of the schedule.

That is, for example, the notification control unit 48 obtains, from the accumulation device 182 via the sensor information obtaining unit 41, one or a plurality of kinds of sensor information in accordance with the transmission destination based on the notification permission table Tbln, among a plurality of kinds of sensor information the notification of which should be made in accordance with the schedule. Then, the notification control unit 48 transmits the obtained sensor information to the transmission destination via the communication unit 45.

For example, the notification control unit 48 recognizes that “o” is included in the lines that respectively correspond to “sampling timing”, “sensor ID”, “LQI”, and “battery voltage” in the column of “wireless manufacturer TC 21a” in the notification permission table Tbln, and determines that the wireless manufacturer TC 21a should be notified of each of the values included in the columns Col1 to Col4 in the csv file 191.

For example, the notification control unit 48 obtains information of each of the values included in the columns Col1 to Col4 in the csv file 191, via the sensor information obtaining unit 41, and transmits each piece of the obtained information as the provision information to the wireless manufacturer TC 21a by e-mail. The notification control unit 48 may transmit the provision information to the terminal computer 21 by a method other than e-mail.

Similarly, for example, the notification control unit 48 recognizes that “o” is included in the lines that respectively correspond to “sampling timing”, “sensor ID”, “temperature”, and “humidity” in the column of “air conditioning management TC 21b” in the notification permission table Tbln, and determines that the air conditioning management TC 21b should be notified of each of the values included in the columns Col1 to Col2 and Col5 to Col6 in the csv file 191. Then, for example, the notification control unit 48 obtains information of each value therein via the sensor information obtaining unit 41, and transmits each piece of the obtained information as the provision information to the air conditioning management TC 21b by e-mail.

Similarly, for example, the notification control unit 48 recognizes that “o” is included in the lines that respectively correspond to “sampling timing”, “sensor ID”, “temperature”, “humidity”, “illuminance”, “acceleration (x)”, “acceleration (y)”, “acceleration (z)”, and “electric current” in the column of “production management TC 21c” in the notification permission table Tbln, and determines that the production management TC 21c should be notified of each of the values included in the columns Col1 to Col2 and Col5 to Col11 in the csv file 191. Then, for example, the notification control unit 48 obtains information of each value therein via the sensor information obtaining unit 41, and transmits each piece of the obtained information as the provision information to the production management TC 21c by e-mail.

[Notification of Alarm]

The following state is assumed in which the sensor information management system 302 is set such that, for example, in a case where at least any one of the measurement value of acceleration (x), the measurement value of acceleration (y), and the measurement value of acceleration (z) exceeds its corresponding predetermined threshold value Thx, Thy, Thz, the production management TC 21c is notified of an alarm indicating that abnormality has occurred in the production device in the facility 3.

For example, the alarm determination unit 42 obtains, via the sensor information obtaining unit 41, information of the measurement values of acceleration (x), acceleration (y), and acceleration (z) in the columns Col8 to Col10 from the csv file 191, every predetermined time period, and monitors abnormal vibration of the production device in the facility 3 on the basis of each piece of the obtained information.

If the measurement value of acceleration (y) exceeds the predetermined threshold value Thy, for example, the alarm determination unit 42 recognizes that abnormal vibration has occurred in the production device in the facility 3, and outputs to the notification control unit 48 an alarm request indicating that the measurement value of acceleration (y) is abnormal.

Upon receiving the alarm request from the alarm determination unit 42, the notification control unit 48 refers to the notification permission table Tbln shown in FIG. 7 retained in the list retaining unit 46, and performs the following process as the notification operation on the basis of the content of the received alarm request.

That is, for example, the notification control unit 48 recognizes that “x”, “x”, and “o” are respectively included in the columns that respectively correspond to “wireless manufacturer TC 21a”, “air conditioning management TC 21b”, and “production management TC 21c”, in the line of “acceleration (y)” in the notification permission table Tbln.

Then, for example, the notification control unit 48 determines that alarm information including the indication that abnormal vibration in the y-axis direction has occurred in the production device in the facility 3 should be transmitted to the production management TC 21c, and transmits the alarm information as the provision information to the production management TC 21c by e-mail.

[Sensor Information the Notification of which is not Made but that can be Accessed]

For example, the information providing unit 43 can provide a provision destination with provision information having a content that is different for each operation. In other words, the information providing unit 43 can provide a provision destination with provision information having a content that is different between the access permission operation and the notification operation, for example.

With reference to FIG. 6 and FIG. 7 again, as shown in the access permission table Tbla in FIG. 6, for example, the production management TC 21c can access the LQI value and the voltage value of the battery 15 in the access permission operation. On the other hand, as shown in the notification permission table Tbln, for example, the production management TC 21c is not notified of the LQI value and the voltage value of the battery 15 in the notification operation.

For example, when the communication quality in the communication between the access point 161 and the sensor 151 is bad, that is, when the value of LQI is small, there are cases where the collection device 181 receives, from the access point 161, sensor information that includes a content different from the measurement result obtained by the sensor 151, and writes a measurement result of an abnormal value into the csv file 191.

Meanwhile, when the voltage of the battery 15 in the sensor 151 is low, there are cases where the sensor element 14 operates in a manner different from that in the normal operation, whereby the measurement result obtained by the sensor 151 shows an abnormal value.

With regard to these, for example, when at least any one of pieces of sensor information that is usually sent once a day, i.e., specifically, the measurement values of temperature, humidity, illuminance, acceleration in each direction, and electric current, is abnormal, the production management TC 21c can receive the LQI value and the voltage value of the battery 15 from the sensor information management device 101 by using an access request, and thus, can quickly grasp the communication quality between the access point 161 and the sensor 151, and the operation state of the sensor 151.

Accordingly, for example, whether the cause of the abnormal value indicated by the sensor information is the communication quality or the operation state of the sensor 151 can be quickly grasped.

That is, with the configuration in which information that is necessary in the normal state is set as the target for periodic notification, and information that is necessary in an abnormal situation is not set as the target for periodic notification but is set as accessible information, it is possible to avoid a state where information that is unnecessary in the normal state is periodically transmitted, and it is possible to quickly obtain information that is necessary in an abnormal state. Therefore, the convenience for the user of each terminal computer 21 in the sensor information management system 302 can be improved, and the transmission efficiency of information can be improved.

[Operation]

FIG. 8 is a flow chart specifying the procedure of operations performed when the sensor information management device according to the embodiment of the present invention provides the provision information based on the content of the sensor information. The sensor information management device and each of the terminal computers 21 in the sensor information management system 302 include a computer, and the processing unit such as a CPU of the computer reads out a program including a part or the entirety of steps in the following flow chart from a memory not shown, and executes the program. The program for each device can be installed from outside. The program for each device is distributed in a state of being stored in a storage medium.

With reference to FIG. 8, first, the sensor information management device 101 waits until receiving an access request from the terminal computer 21, until a notification timing based on a schedule, i.e., the predetermined time tn, has come, or until the value indicated by the sensor information becomes abnormal (NO in step S102, NO in step S104, and NO in step S106).

Next, upon receiving the access request from the terminal computer 21 (YES in step S102), the sensor information management device 101 performs an access request process which is a process made in response to the access request (step S108).

When the notification timing has come (YES in step S104), the sensor information management device 101 performs a notification process (step S110).

When the value indicated by the sensor information becomes abnormal (YES in step S106), the sensor information management device 101 performs an alarm process (step S112).

Then, the sensor information management device 101 waits again until receiving an access request from the terminal computer 21, until the notification timing has come, or until the value indicated by the sensor information becomes abnormal (NO in step S102, NO in step S104, and NO in step S106).

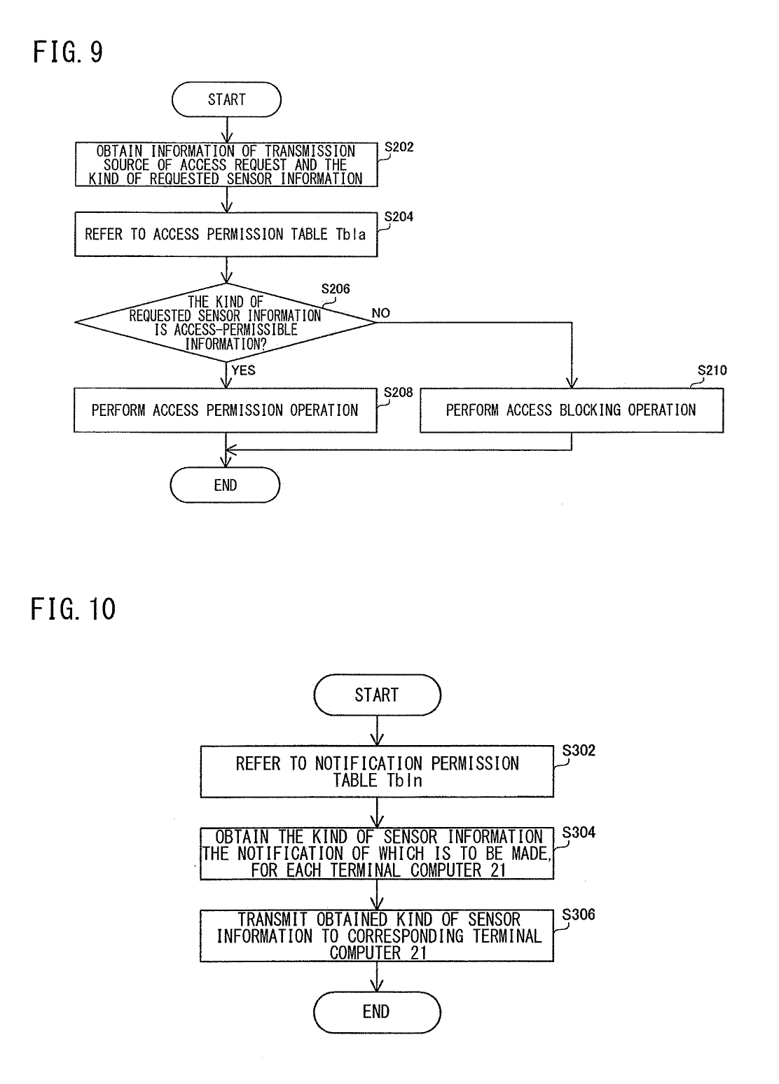

FIG. 9 is a flow chart specifying the procedure of operations performed when the sensor information management device according to the embodiment of the present invention has received an access request from a terminal computer. FIG. 9 shows the details of the access request process in step S108 shown in FIG. 8.

With reference to FIG. 9, first, on the basis of the received access request, the sensor information management device 101 obtains the information of the terminal computer 21 being the transmission source of the access request and the kind of the requested sensor information (step S202).

Next, the sensor information management device 101 refers to the access permission table Tbla shown in FIG. 6 (step S204).

Next, if the sensor information management device 101 determines that the kind of the requested sensor information is access-permissible information on the basis of the access permission table Tbla (YES in step S206), the sensor information management device 101 performs the access permission operation that permits the terminal computer 21 to access the requested sensor information (step S208).

On the other hand, if the sensor information management device 101 determines that the kind of the requested sensor information is not access-permissible information (NO in step S206), the sensor information management device 101 performs the access blocking operation that prohibits the terminal computer 21 from accessing the requested sensor information (step S210).

FIG. 10 is a flow chart specifying the procedure of operations performed when the sensor information management device according to the embodiment of the present invention notifies a terminal computer of sensor information. FIG. 10 shows the details of the notification process in step S110 shown in FIG. 8.

With reference to FIG. 10, first, the sensor information management device 101 refers to the notification permission table Tbln shown in FIG. 7 (step S302).

Next, the sensor information management device 101 obtains the kind of sensor information the notification of which is to be made, for each terminal computer 21 (step S304).

Next, the sensor information management device 101 transmits the obtained kind of sensor information to the corresponding terminal computer 21 (step S306).

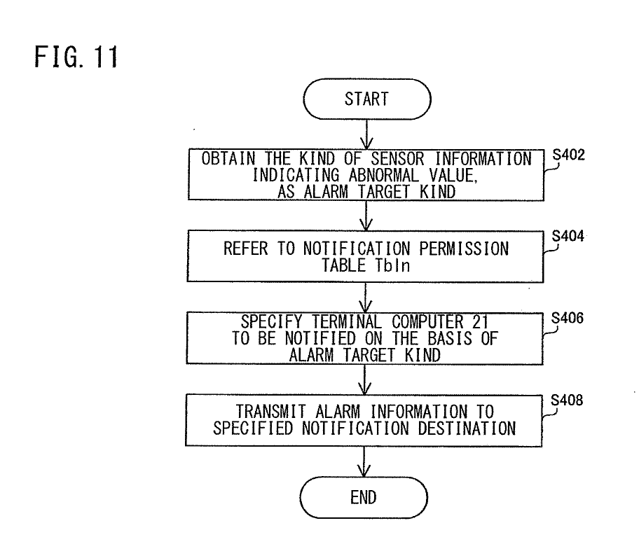

FIG. 11 is a flow chart specifying the procedure of operations performed when the sensor information management device according to the embodiment of the present invention notifies a terminal computer of alarm information. FIG. 11 shows the details of the alarm process in step S112 shown in FIG. 8.

With reference to FIG. 11, first, the sensor information management device 101 obtains the kind of sensor information indicating an abnormal value, as the kind to be alarmed (step S402).

Next, the sensor information management device 101 refers to the notification permission table Tbln shown in FIG. 7 (step S404).

Next, on the basis of the kind to be alarmed, the sensor information management device 101 specifies a terminal computer 21 being the notification destination, in the notification permission table Tbln (step S406).

Next, the sensor information management device 101 transmits alarm information to the specified terminal computer 21 being the notification destination (step S408).

Although the sensor information management device according to the embodiment of the present invention is configured such that the accumulation device 182 which stores sensor information is provided outside the sensor information management device, the present invention is not limited thereto. The sensor information management device may be configured to include a storage unit which stores sensor information, for example.

In the sensor information management system 302 according to the embodiment of the present invention, the accumulation device 182 is configured to store the sensor measurement information indicating the measurement result obtained by the sensor 151 and the communication quality information indicating the communication quality of the sensor 151. However, the present invention is not limited thereto. It is sufficient that the accumulation device 182 is configured to store at least either one of the sensor measurement information and the communication quality information, for example. Specifically, for example, in a case where the accumulation device 182 stores the communication quality information, the information providing unit 43 changes the content of the provision information based on the content of the communication quality information, in accordance with what the provision destination is, and provides the changed content.

Meanwhile, as one mode utilizing the M2M system described above, it is conceivable to: set one or a plurality of wireless terminal devices that can each wirelessly transmit a measurement result obtained by a sensor; collect measurement results from the wireless terminal devices; and provide information based on the collected measurement results and the like. In such a utilization mode, there is a demand for a technology that can provide appropriate information.

With regard to this, in the sensor information management device according to the embodiment of the present invention, the sensor information obtaining unit 41 obtains sensor information from the accumulation device 182 which stores sensor information indicating at least either one of the measurement result obtained by the sensor 151 and the communication quality of the sensor 151. The information providing unit 43 provides provision information based on the content of the sensor information obtained by the sensor information obtaining unit 41. Then, the information providing unit 43 changes the content of the provision information in accordance with what the provision destination of the provision information is.

With this configuration, in accordance with what the provision destination of the provision information is, the content of the provision information can be restricted, or provision of the provision information can be avoided, for example. Accordingly, confidentiality can be maintained, and the transmission efficiency of the provision information can be improved.

Therefore, with respect to the sensor information management device according to the embodiment of the present invention, in a configuration in which measurement results obtained by the sensor 151 are collected and provision information based on the collected measurement results and the like is provided, it is possible to provide appropriate provision information.

In the sensor information management device according to the embodiment of the present invention, the information providing unit 43 provides, as the provision information, one or a plurality of kinds of sensor information in accordance with what the provision destination is, among a plurality of kinds of sensor information stored in the accumulation device 182.

With this configuration, even in a case where the kind of sensor information that should be kept confidential differs depending on what the provision destination is, it is possible to provide appropriate sensor information.

In the sensor information management device according to the embodiment of the present invention, the information providing unit 43 can perform the access permission operation that provides a provision destination with the provision information in response to a request from the provision destination, and can perform the notification operation that provides a provision destination with the provision information, irrespective of the request. In addition, the information providing unit 43 can provide a provision destination with the provision information having a content that is different for each of the operations above.

Thus, for example, in a configuration in which provision information that is necessary in a normal state is provided through the notification operation, and provision information that is necessary in an abnormal situation is not provided through the notification operation but is provided through the access permission operation, it is possible to avoid a state where provision information that is unnecessary in a normal state is periodically transmitted, and it is possible to quickly provide provision information that is necessary in an abnormal state. Therefore, convenience for the provision destination can be improved, and the transmission efficiency of information can be further improved.

It should be understood that the above embodiment is merely illustrative and not restrictive in all aspects. The scope of the present invention is defined by the scope of the claims rather than the above description, and is intended to include meaning equivalent to the scope of the claims and all modifications within the scope.

The above description includes the features in the additional notes below.

[Additional Note 1]

A sensor information management device including:
a sensor information obtaining unit configured to obtain sensor information, from a storage unit configured to store the sensor information indicating at least either one of a measurement result obtained by a sensor and a communication quality of the sensor; and
an information providing unit configured to provide provision information based on a content of the sensor information obtained by the sensor information obtaining unit, wherein
the information providing unit changes a content of the provision information in accordance with what a provision destination of the provision information is,
the sensor information is a measurement value of at least any one of LQI, battery voltage, temperature, humidity, illuminance, acceleration, and electric current,
the provision information is at least either one of alarm information and a part or an entirety of the sensor information, and
the information providing unit performs, as an operation that provides the provision information, at least either one of an operation of transmitting the provision information and an operation of permitting access to the provision information.

### REFERENCE SIGNS LIST

11 antenna
12 wireless IC (Integrated Circuit)
13 microcomputer
14A to 14F sensor element
15 battery
21a, 21b, 21c terminal computer
41 sensor information obtaining unit
42 alarm determination unit
43 information providing unit
45 communication unit
46 list retaining unit
47 access control unit
48 notification control unit
101 sensor information management device
151A, 151B sensor
161 access point
181 collection device
182 accumulation device (storage unit)
301 sensor information collection system
302 sensor information management system

1. A sensor information management device comprising:
a sensor information obtaining unit configured to obtain sensor information, from a storage unit configured to store the sensor information indicating at least either one of a measurement result obtained by a sensor and a communication quality of the sensor; and
an information providing unit configured to provide provision information based on a content of the sensor information obtained by the sensor information obtaining unit, wherein
the information providing unit executes at least one of restriction of a content of the provision information and avoidance of provision of the provision information in accordance with what a provision destination of the provision information is.

2. The sensor information management device according to claim 1, wherein
the information providing unit provides, as the provision information, one or a plurality of kinds of the sensor information in accordance with what the provision destination is, among a plurality of kinds of the sensor information stored in the storage unit.

3. The sensor information management device according to claim 1, wherein
the information providing unit is capable of performing a first operation that provides the provision destination with the provision information in response to a request from the provision destination, and a second operation that provides the provision destination with the provision information irrespective of the request, and
the information providing unit is capable of providing the provision destination with the provision information having a content that is different between the first operation and the second operation.

4. A sensor information management method to be performed in a sensor information management device, the method comprising the steps of:
obtaining sensor information from a storage unit configured to store the sensor information indicating at least either one of a measurement result obtained by a sensor and a communication quality of the sensor; and
providing provision information based on a content of the obtained sensor information, wherein
in the step of providing the provision information, at least one of restriction of a content of the provision information and avoidance of provision of the provision information is executed in accordance with what a provision destination of the provision information is.

5. A non-transitory computer readable storage medium storing a sensor information management program to be used in a sensor information management device, the program causing a computer to execute the steps of:
obtaining sensor information from a storage unit configured to store the sensor information indicating at least either one of a measurement result obtained by a sensor and a communication quality of the sensor; and
providing provision information based on a content of the obtained sensor information, wherein
in the step of providing the provision information, at least one of restriction of a content of the provision information and avoidance of provision of the provision information is executed in accordance with what a provision destination of the provision information is.

6. The sensor information management device according to claim 2, wherein
the information providing unit is capable of performing a first operation that provides the provision destination with the provision information in response to a request from the provision destination, and a second operation that provides the provision destination with the provision information irrespective of the request, and
the information providing unit is capable of providing the provision destination with the provision information having a content that is different between the first operation and the second operation.
